(19) United States
(12) Patent Application Publication
(10) Pub. No.: US 2023/0153902 A1
(43) Pub. Date: May 18, 2023

(54) Method and Tool to compute discount-score of security's stock price

(71) Applicant: Salyl Siddharth Bhagwat, Sunnyvale, CA (US)

(72) Inventor: Salyl Siddharth Bhagwat, Sunnyvale, CA (US)

(21) Appl. No.: 17/527,179

(22) Filed: Nov. 16, 2021

(51) Int. Cl. G06Q 40/04; G06Q 50/00

(52) U.S. Cl. CPC G06Q 40/04; G06Q 50/01

(57) ABSTRACT

Disclosure of a method and tool to compute score of security to indicate the degree of perceived discount or perceived premium at its current stock price. Technical analysis, Linear regression, digital filtering, statistical analysis, and publicly available information is used to determine a current average price point of the stock and a score is generated based on the degree of the current stock price being above or below the determined average price point. This score can be used to make quick and informed buy/sell decision. The method used in the tool can efficiently compute scores for entire watch list of stocks thereby giving user the ability to complete analysis and decision making on large number of stocks in a fraction of time compared to manual analysis.

### BACKGROUND OF THE INVENTION

### Field of Endeavor

Investment tools for planning, selection, or evaluation of securities (US patent classification G06Q 40/06)

### Background

Most consumers would appreciate a discount on items they want to purchase. Investors and Traders of securities are no different in this respect in that they would also like a discount on stocks they purchase. However, unlike the consumer goods, stocks do not have a discount advertised in the stock market and the stock prices are not static. The tools available to the stock traders and investors for making buy-/sell-decisions are at times esoteric, cumbersome, and not easy to quickly determine discount on stocks in their entire watch lists. A strong criteria and easy indicator are required to quickly determine if a stock is trading at a discount or at a premium so that an informed and timely decision to buy or sell security in the watch list can be made.

### SUMMARY OF THE INVENTION

This is a simplified summary of the invention. For the entirety of the invention, please refer to the detailed description section.

This invention is a method to analyze stocks and compute respective scores to indicate the degree of perceived discount or perceived premium at its current stock price.

This method can be used in a software tool that can run on a computer system (example: personal computer, laptop, mobile phone, cloud server) that has a microprocessor, memory and storage. The stock data that is necessary for analysis can be obtained over the internet (FIG. 1A) or can be made available via storage medium (FIG. 1B).

This method generates score for each stock between −1 and +1. Score closer to −1 indicates perceived high premium and score closer to +1 indicates perceived high discount. For example: a score of 0.8 on a stock implies that the current stock price is perceived to have major discount whereas a score of −0.8 implies that the current stock price is perceived to have a major premium. Please refer to FIG. 2 that illustrates the score range.

Technical analysis, Linear regression, digital filtering, statistical analysis, and publicly available information

This method processes stock's historical price data (of a specified period such as 5 years) using technical analysis, Linear regression, digital filtering, statistical analysis, and publicly available information to establish an average point for each of these techniques and generates scores from each of those techniques based on how much above or below the average point is the current indicator. Details of techniques in later section.

This method also processes stock options data to establish a bullish or bearish trend and generates positive score for bullish trend and negative score for bearish trend.

This method also processes information from available analyst recommendations to generate scores based on ratio of positive/negative recommendations and upgrades/downgrades. In the absence of analyst recommendations, fundamental analysis is used to compute equivalent score (details in later section).

This method also extracts sentiment scores from social media websites to factor into the overall score.

This method assigns weightage (details in next section) to scores from each of the techniques.

This method computes overall score by doing summation of scores from all mentioned techniques divided by 100 (details in next section). This produces score between −1 and +1 where stocks perceived at a premium have smaller scores (towards −1) and stocks perceived at a discount have higher scores (towards +1). Please refer to FIG. 2 that illustrates the score range.

Using this method in the tool quickly computes the score for single stock or each stock in the watch list there by making the perception of current price point clear.

### BRIEF DESCRIPTION OF DRAWINGS

Include a listing of all figures by number (example FIG. 1A) and with corresponding statements explaining what each figure depicts.

FIG. 1A: Computer system with internet access that this method can be used on

FIG. 1B: Computer system without internet access that this method can be used on

FIG. 2: Range of score that this method uses

FIG. 3: Data used by this method for processing

FIG. 4: High-level flow chart overview

FIG. 5: Flow chart for analyst recommendations data analysis and scoring

FIG. 6: Flow chart for Options data analysis and scoring

FIG. 7: Flow chart for Price data analysis and scoring

FIG. 8: Flow chart for RSI based analysis and scoring

FIG. 9: Flow chart for MFI based analysis and scoring

FIG. 10: Flow chart for stochastic indicator-based analysis and scoring

FIG. 11: Flow chart for Bollinger bands-based analysis and scoring

FIG. 12: Flow chart for MACD based analysis and scoring

FIG. 13: Flow chart for Kalman filter-based analysis and scoring

FIG. 14: Flow chart for OLS based analysis and scoring

FIG. 15: Flow chart for social media sentiment-based analysis and scoring

### DETAILED DESCRIPTION OF THE INVENTION

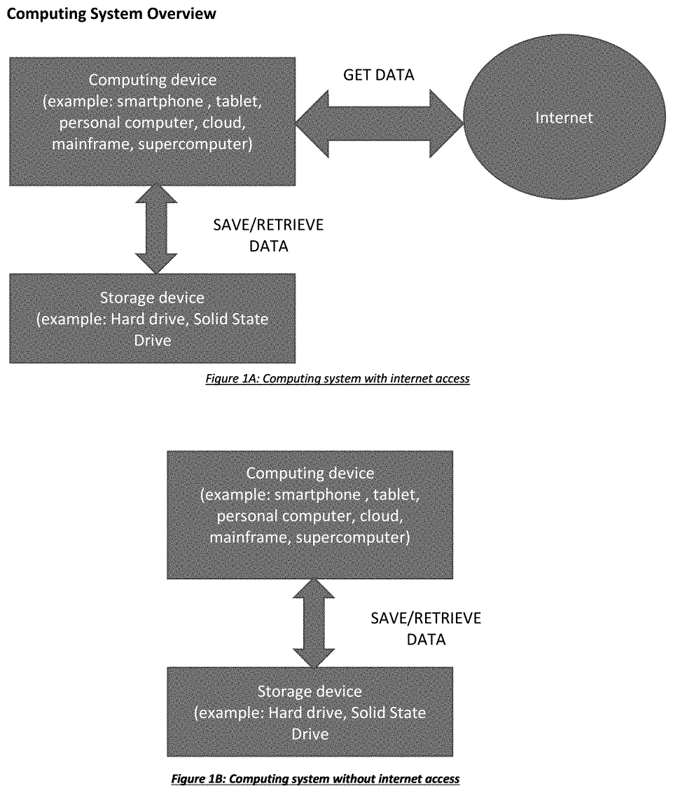

As shown in FIG. 1A and FIG. 1B, this method can be used on a system with processor, Random Access Memory with or without Internet. In case it is used without Internet access then it needs access to storage device that has all the data necessary to complete the analysis and scoring.

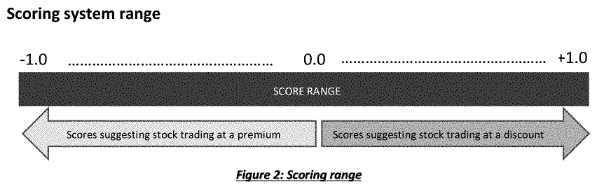

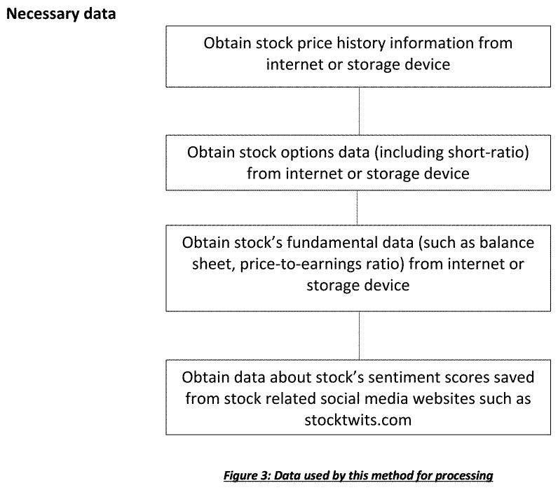

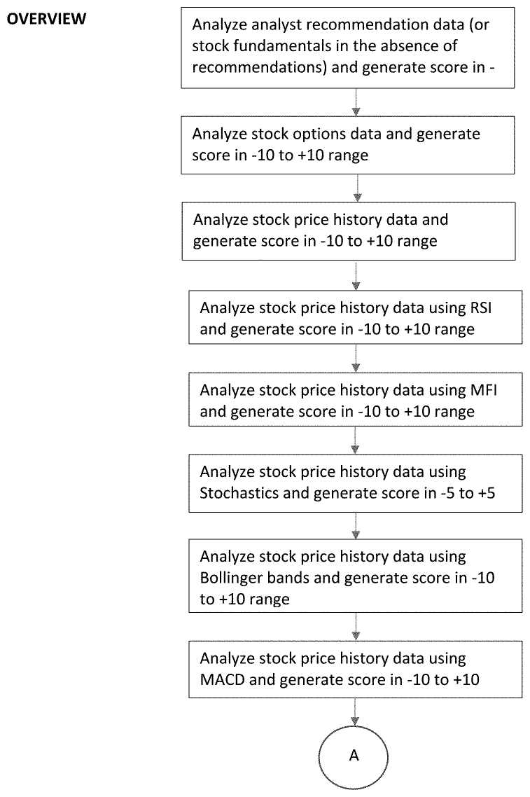

As shown in FIG. 2, this method generates score between −1 and +1. Score closer to −1 indicates perceived high premium and score closer to +1 indicates perceived high discount. For example: a score of 0.8 on a stock implies that the current stock price is perceived to have major discount whereas a score of −0.8 implies that the current stock price is perceived to have a major premium.

As shown in FIG. 3, the data that this method uses (either from Internet or storage device) is the stock price history information, stock options data, Analysts recommendations (or Company fundamentals data such as balance sheet, price to earnings ratio etc. if Analyst recommendations data don't exist for the stock) and Social media sentiment data of the stock.

### Method Overview

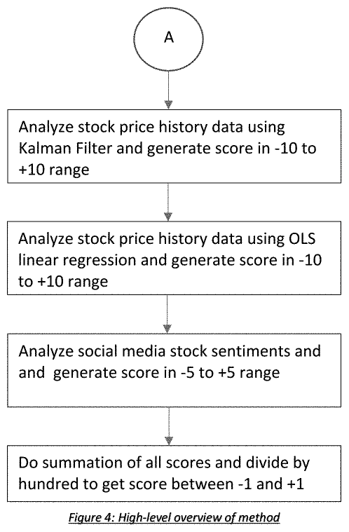

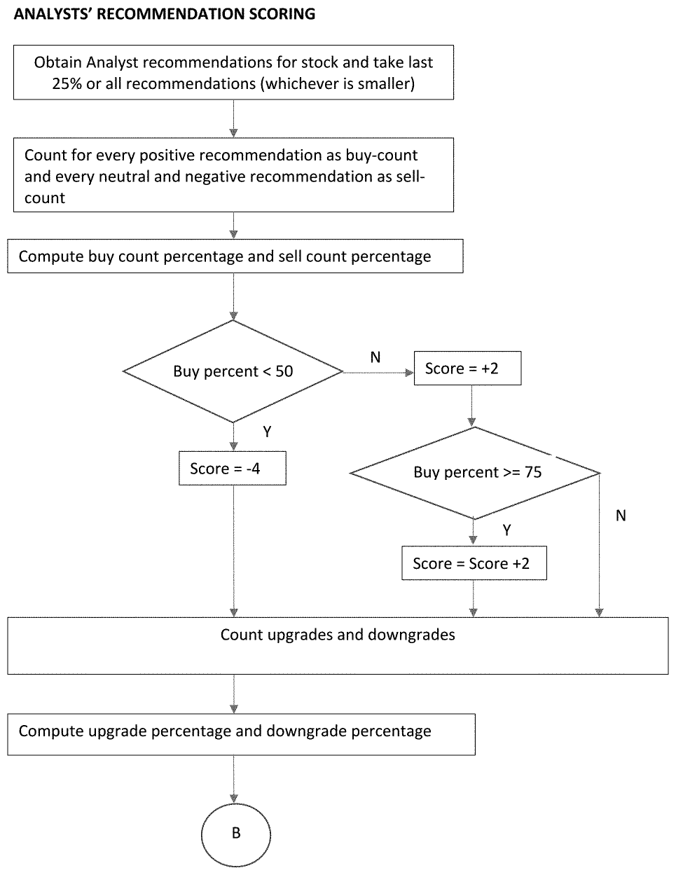

As shown in FIG. 4, this method processes the data mentioned in FIG. 3 to complete the analysis and scoring using following techniques:
a) Analyzes Analysts' recommendations data and computes a score in −10 to +10 range
b) Analyzes the stock options data and computes a score in −10 to +10 range
c) Analyzes price history information and computes a score in −10 to +10 range
d) Analyzes price history information to extract Relative Strength Index indicators and computes a score in −10 to +10 range
e) Analyzes price history information to extract Money Flow Index indicators and computes a score in −10 to +10 range
f) Analyzes price history information to extract indicators from Stochastic oscillator and computes a score in −5 to +5 range
g) Analyzes price history information to extract indicators from Bollinger Bands and computes a score in −10 to +10 range
h) Analyzes price history information to extract information from MACD indicators and computes a score in −10 to +10 range
i) Analyzes price history information by passing it through digital filter (Kalman Filter) to extract indicators and computes a score in −10 to +10 range
j) Analyzes price history information by doing Ordinary Least Squares Linear Regression to extract indicators and computes a score in −10 to +10 range
k) Analyzes sentiment information of the stock as obtained from social media websites (such as stocktwits.com) and computes a score in −5 to +5 range
l) To compute the overall score, this method does a summation of scores from above mentioned a-k steps, divides the result by 100 and returns a score in −1 to +1 range

### 1) Details of Analysis and Scoring Based on Analysts' Recommendations

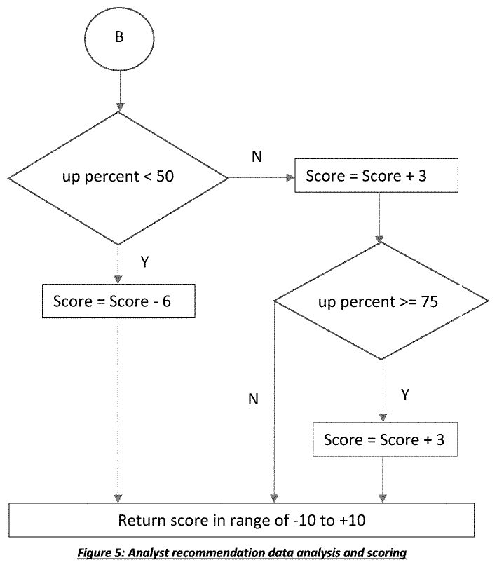

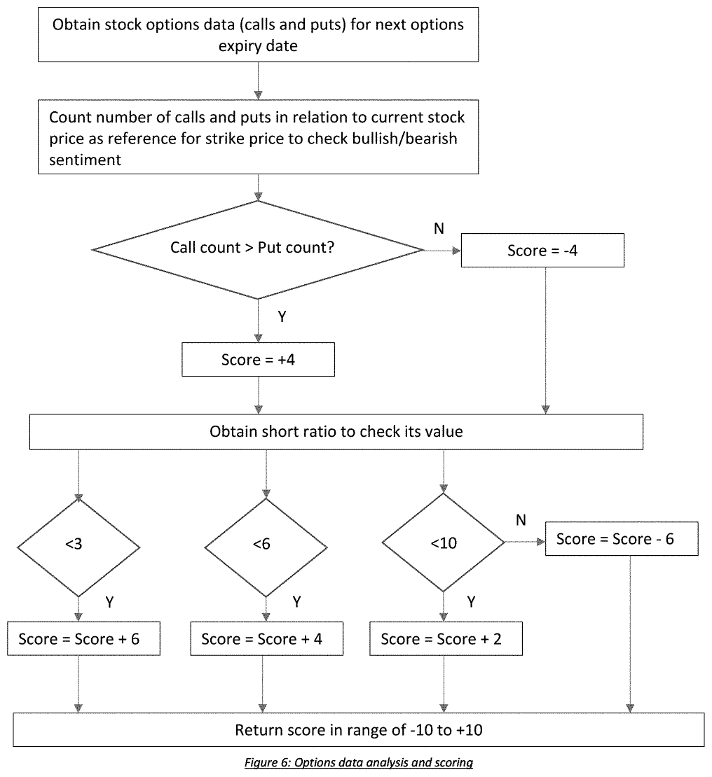

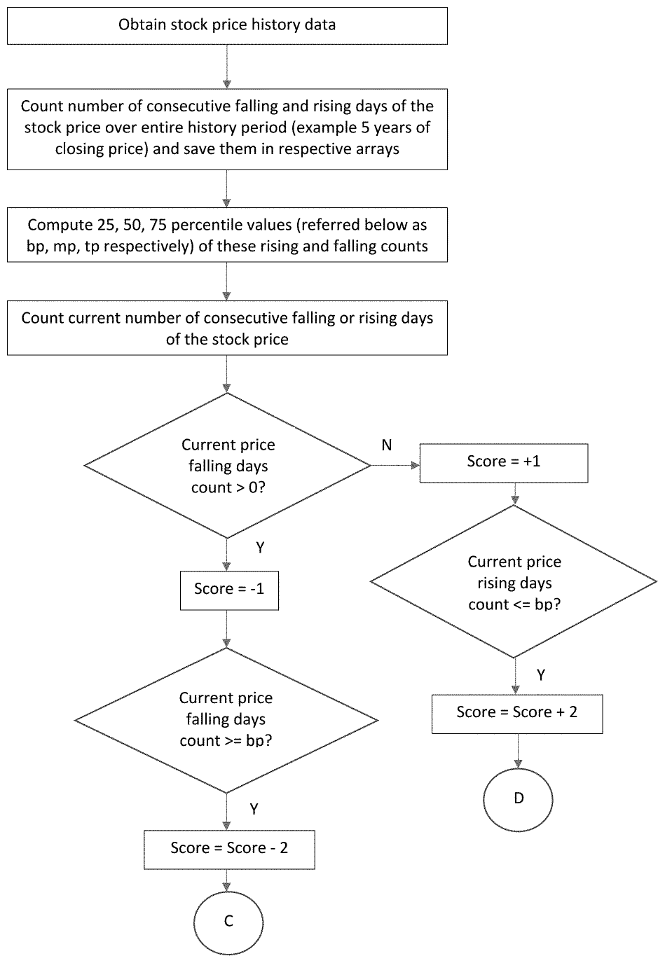

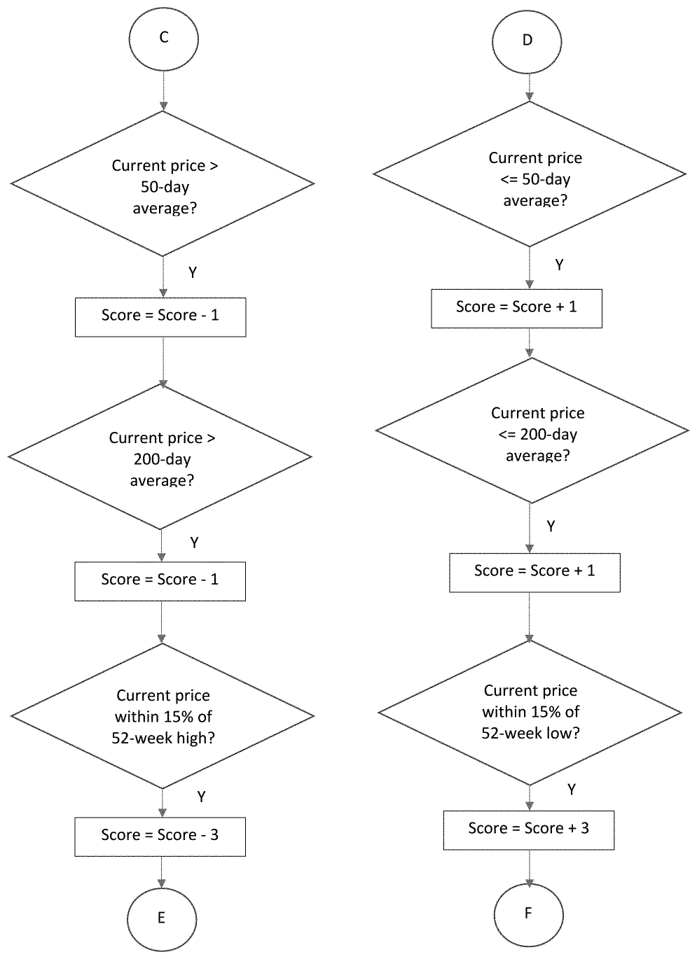

a) As shown in FIG. 5, this method extracts 25% of most recent recommendations data or all recommendations (whichever is smaller) to filter out obsolete data. It scans the data for recommendations (for example: ‘Buy’, ‘Strong Buy’, ‘Overweight’, ‘Sell’, ‘Strong Sell’) and counts the number of positive and neutral/negative recommendations and generates a score accordingly (actual score shown in the flow chart in FIG. 5). Positive scoring if more positive recommendations and negative scoring if more neutral/negative recommendations. This makes up 40% of the total score generated from Analysts' recommendations

b) The method also looks for “upgrades” and “downgrades” information and counts them to check if upgrade percentage is more than the downgrades. Positive scoring if upgrades percentage is more and Negative scoring otherwise (actual score shown in the flow chart in FIG. 5). This makes up 60% of the total score generated from Analysts' recommendations

c) Score generated by this method from Analysts' recommendations analysis is in −10 and +10 range.

### 2) Details of Analysis and Scoring Based on Options Data

a) As shown in FIG. 6, this method extracts the next options expiry date from the collected information and uses it to extract corresponding call and put data. This method uses the stock price as a reference for strike price and counts number of calls and puts to gauge the bullish or bearish sentiment. More number of calls than puts generates positive score, negative score otherwise. The exact scoring is shown in the flow chart in FIG. 6). The calls/puts scoring makes up 40% of total score generated from options data

b) As shown in FIG. 6, this method extracts the short ratio information for the stock and computes score. Lower short ratio is deemed better, and scoring is done accordingly. Exact scoring is shown in the flow char in FIG. 6. The short-ratio scoring makes up 60% of the total score generated from options data

c) Score generated by this method from options data analysis is in −10 and +10 range

### 3) Details of Analysis and Scoring Based on Historical Price Data

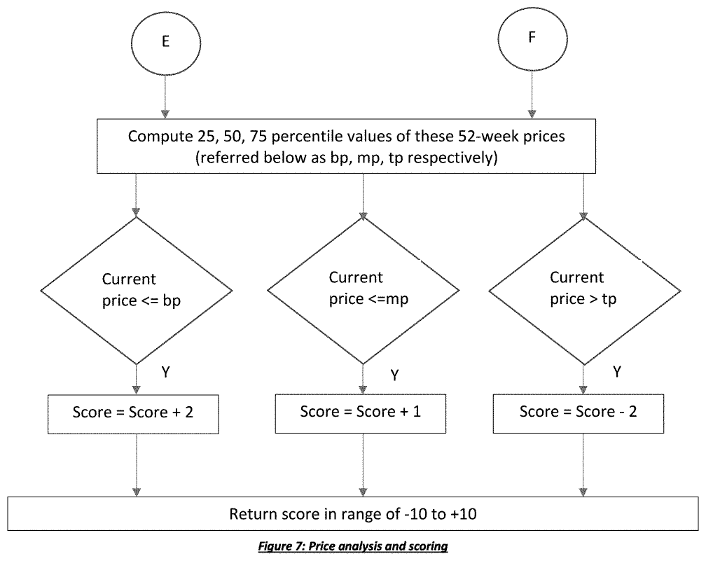

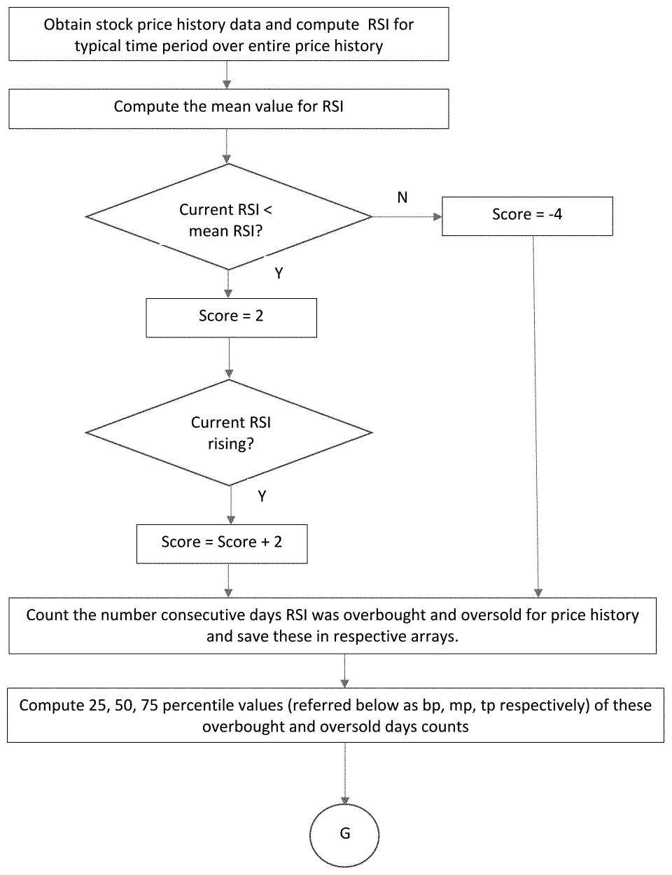

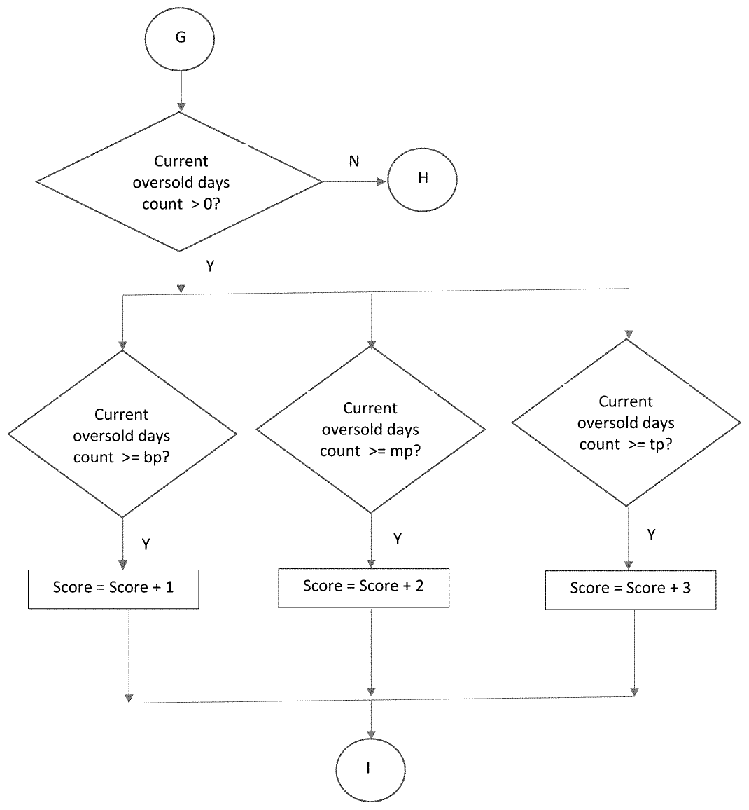

a) As shown in FIG. 7, this method counts consecutive number of days when price fell and consecutive number of days when the price rose in the historical price information. It computes 25, 50 and 75 percentile values to compare against current number of days where price is falling or rising. If the price is falling, then negative score is assigned and if the price is rising then a positive score is assigned as FIG. 7. This count of falling/rising days makes up 30% of the score generated from price analysis.

b) This method compares current price with 50-day average, 200-day average and 52-week high/low values and assigns positive score when price is lower compared to these values and negative score when price is higher compared to these values. The exact scoring is shown in FIG. 7. This makes up 50% of the total score generated from price data

c) This method extracts 1-year price data and computes 25, 50, 75 percentile values to compare against current stock price. If the current price is in lower quantiles, then positive score is assigned and if in higher percentile then negative score is assigned proportionately as shown in FIG. 7. This makes up 20% of the total score generated from price data

d) Score generated by this method from price data analysis is in −10 and +10 range

### 4) Details of Analysis and Scoring Based on Relative Strength Index

Relative Strength Index (RSI) is a momentum indicator that measures the magnitude of “recent” price changes. This can be used to estimate bullish and bearish price momentum. Details about RSI can be found here: https://www.investopdia.com/terms/r/rsi.asp.

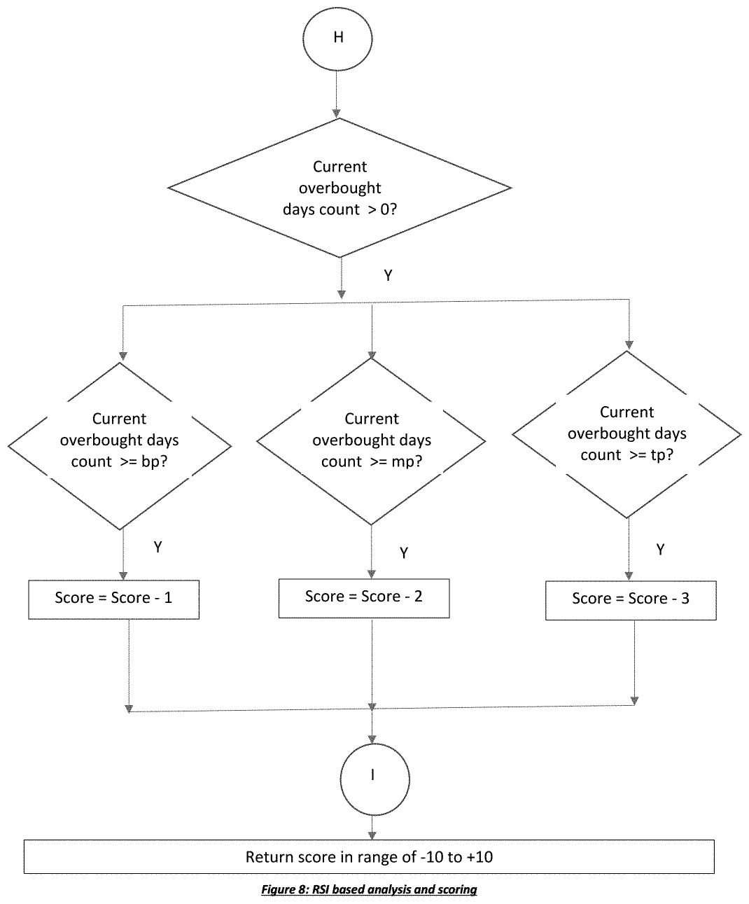

a) As shown in FIG. 8, this method processes historical price data to generate RSI data and computes the mean value for RSI. This mean value is used as a “historical average point” to compare against current RSI value to estimate if current RSI is below or above average. Positive scoring if current RSI is below average and Negative score otherwise. Current RSI rising vs falling also contributes to this score. This step makes up 40% of the score generated from RSI indicators

b) This method counts the consecutive days the RSI was historically either oversold (RSI value of <30) or overbought (RSI value of >70) and computes 25, 50, 75 percentile values of overbought/oversold days to be able to compare these with current number of overbought/oversold days. If current RSI shows oversold days, then positive scoring is done proportionate to whether the current number of oversold days falls in bottom, middle or top quantile based on values generated from historical RSI data. If current RSI shows overbought days, then negative scoring is done proportionate to whether the current number of overbought days falls in bottom, middle or top quantile based on values generated from historical RSI data. This step makes up 60% of the score generated from RSI indicators

c) Score generated by this method from RSI based analysis is in −10 to +10 range

### 5) Details of Analysis and Scoring Based on Money Flow Index

Money Flow Index (MFI) is a technical oscillator that generates overbought/oversold signals using price and volume data (as compared to RSI which doesn't use volume). So, this method is using MFI to add volume-weighted component in analysis. In addition, divergence between MFI and price could signal direction change so this method uses this for detecting potential reversal.

Details on MFI can be found here: https://www.investopdia.com/terms/m/mfi.asp.

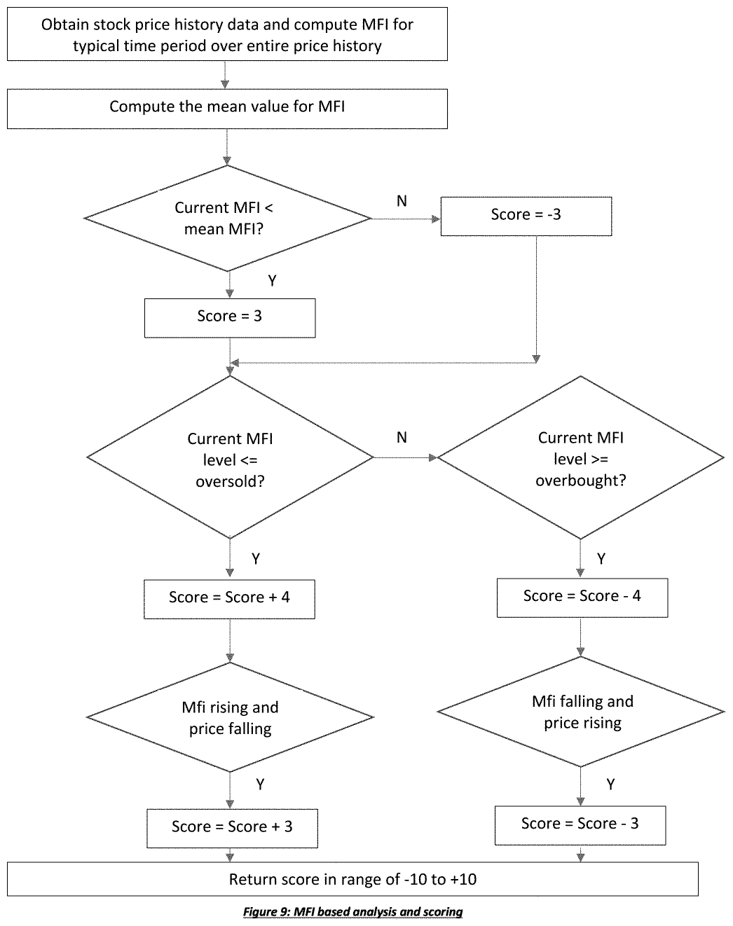

a) As shown in FIG. 9, this method processes historical price data to generate MFI data and computes the mean value for MFI. This mean value is used as a “historical average point” to compare against current MFI value to estimate if current MFI is below or above average. Positive scoring if current MFI is below average and Negative scoring otherwise. This step makes up 30% of the score generated from MFI indicators

b) This method checks if current MFI level is oversold or overbought and generates scores accordingly. If current MFI is oversold (MFI value <=20) then positive score is assigned. If current MFI is overbought (MFI value >=80) then negative score is assigned. FIG. 9 shows the scoring. This step makes up 40% of the score generated from MFI indicators

c) This method checks for price reversal indicators to factor it into the score. If MFI is rising and price is falling, then this means that price could start rising. As a result, a positive score is assigned. If MFI is falling and price is rising, then this could mean that price could start falling. As a result, a negative score is assigned. This step makes up 30% of the score generated from MFI indicators. FIG. 9 shows scoring.

d) Score generated by this method from MFI based analysis is in −10 to +10 range

### 6) Details of Analysis and Scoring Based on Stochastic Oscillator

Stochastic oscillator is a momentum indicator that shows when stock has moved to overbought or oversold position. Stochastic oscillators are based on the idea that closing prices should confirm the trend. This oscillator compares the closing price to a range of its prices over a certain period. Stochastic responds more to price movements and works best when market is trading in consistent ranges. Details about Stochastic oscillator can be found here: https://www.investopedia.com/terms/s/stochasticoscillator.asp.

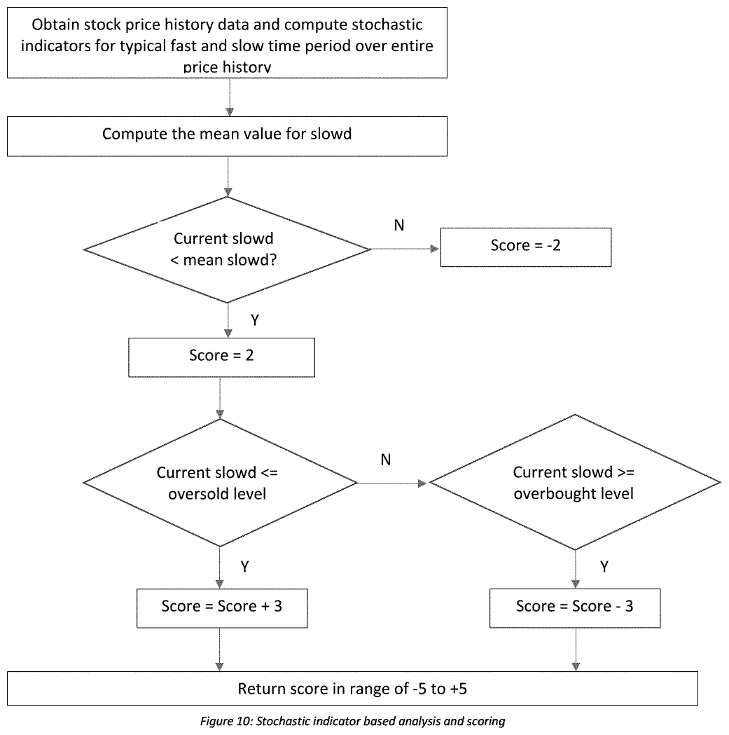

a) As shown in FIG. 10, this method processes historical price data to generate stochastic oscillator data (slow and fast) and computes the mean value for slowd. This mean value is used as a “historical average point” to compare against current slowd level to estimate if current slowd is below or above average. Positive scoring if current slowd is below average and negative scoring otherwise. This step makes up 40% of the score generated from MFI indicators

b) This method checks if current slowd level is oversold (slowd <=20) or overbought (slowd >=80) and generates scores accordingly. If current slowd is oversold positive score is assigned. If current MFI is overbought (MFI value >=80) then negative score is assigned. FIG. 10 shows the scoring. This step makes up 60% of the score generated from MFI indicators

c) Score generated by this method from Stochastics oscillator based analysis is in −5 to +5 range.

### 7) Details of Analysis and Scoring Based on Bollinger Bands

Bollinger bands consist of 3 lines where the middle band is a simple moving average (typically average of closing prices from a predefined period), upper and lower lines are 2 standard deviations +/− respectively.

More details on Bollinger Bands can be found here:

https://www.investopedia.com/terms/b/bollingerbands.asp

This method uses Bollinger band to check how far has current price deviated from the middle line to estimate if current price is below or above average.

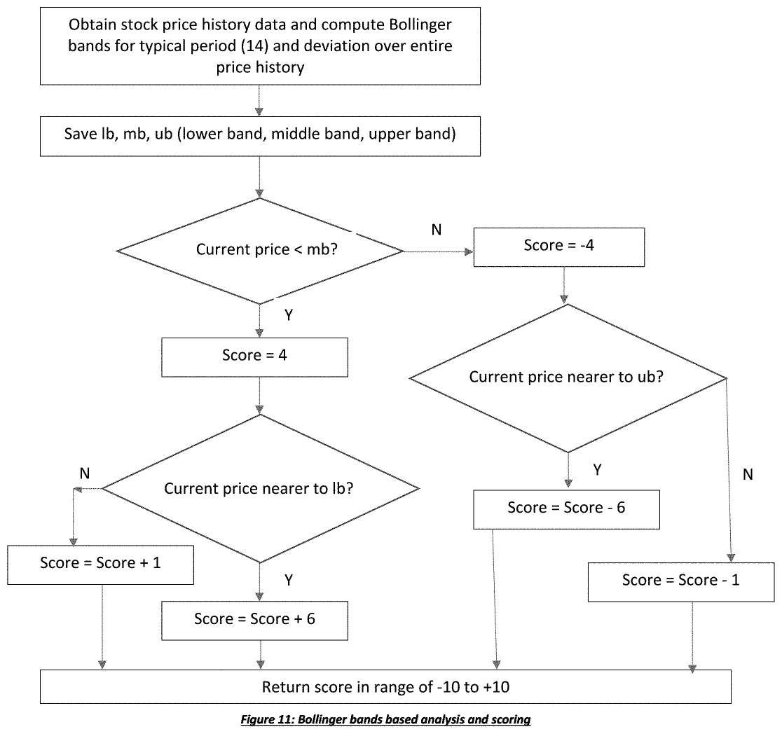

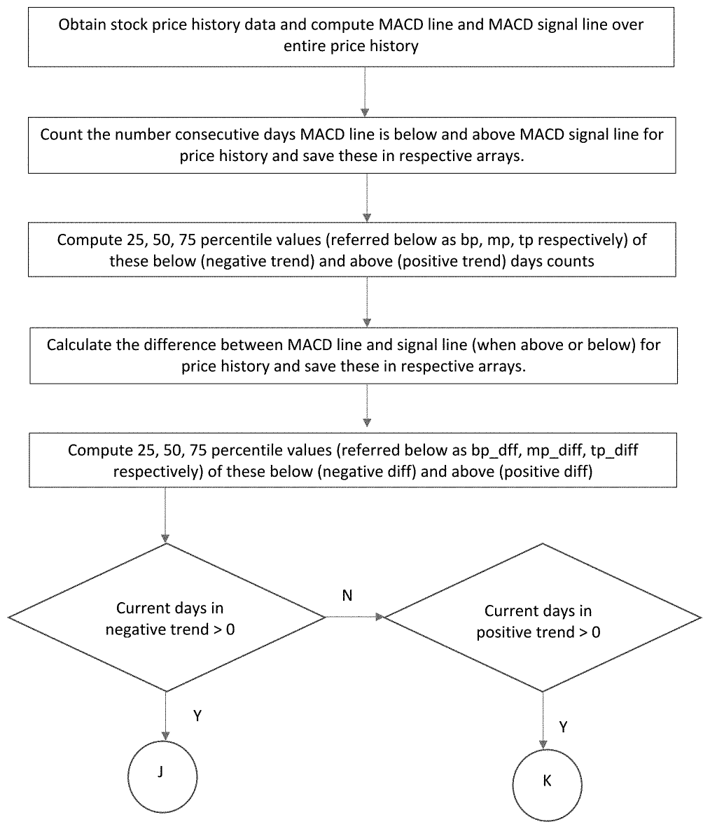

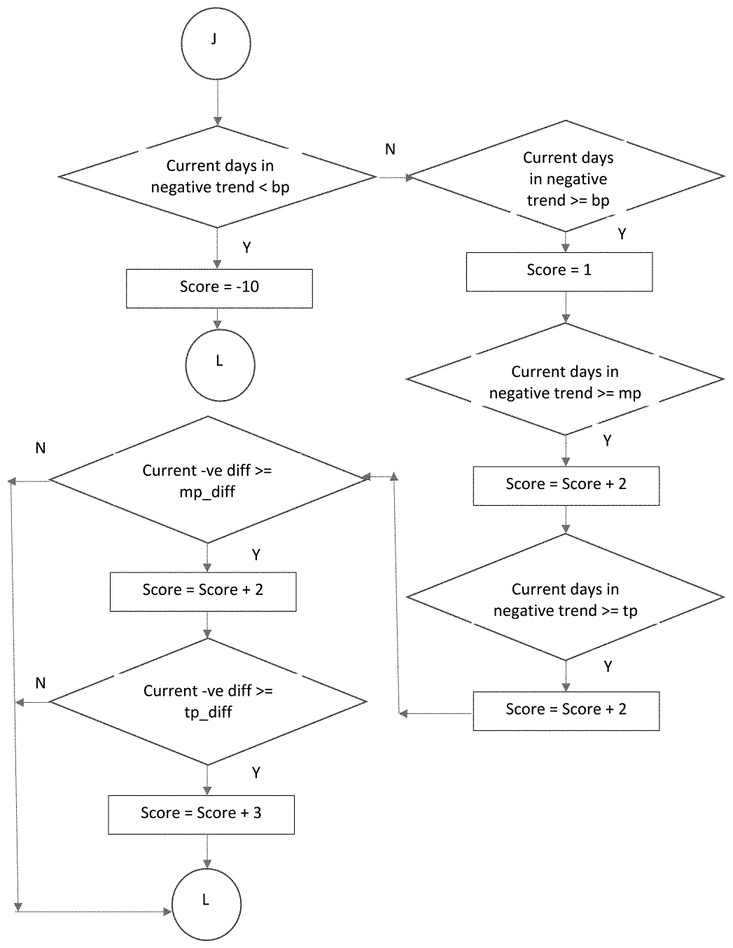

a) As shown in FIG. 11, this method processes historical price data to generate Bollinger Bands and compares the current price with middle band value. If the current price is below the middle band, then positive score is generated and if it is above the middle band then negative score is generated. This step makes up 40% of the score generated from Bollinger bands

b) Once it is determined that current price is “below average”, this method checks to see if current price is near lower or middle band to assign a proportionate positive score. Once it is determined that current price is “above average”, this method checks to see if current price is near middle or upper band to assign a proportionate negative score. FIG. 11 shows the scoring. This step makes up 60% of the score generated from MFI indicators

c) Score generated by this method from Bollinger-band-based analysis is in −10 to +10 range.

### 8) Details of Analysis and Scoring Based on MACD

Moving Average Convergence Divergence (MACD) is a momentum indicator. MACD line is calculated by subtracting 26-period EMA (Exponential Moving Average) from 12-period EMA. A 9-days EMA line is used as a reference and when MACD crosses above, it is deemed as a buy signal and when below it is deemed as a sell signal.

Refer to https://www.investopedia.com/terms/m/macd.asp for more details on MACD.

This method does not use MACD's buy/sell signal. Instead, this method uses the historical number of days below/above signal line and historical difference between MACD and signal line to compare with current days below/above signal line and current difference between MACD and signal line respectively to compute positive or negative score.

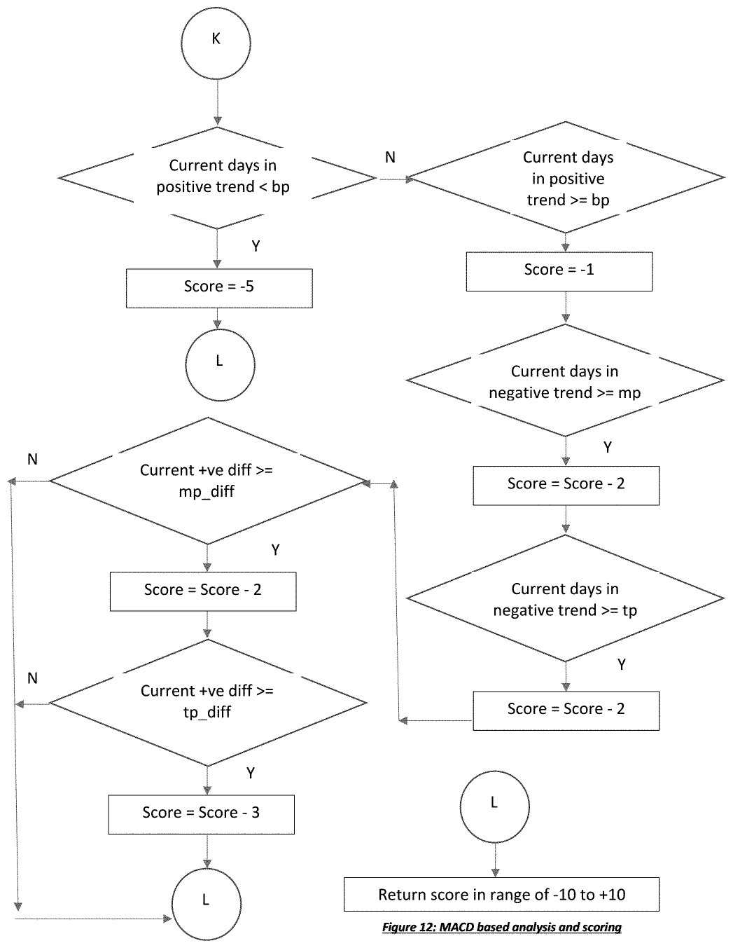

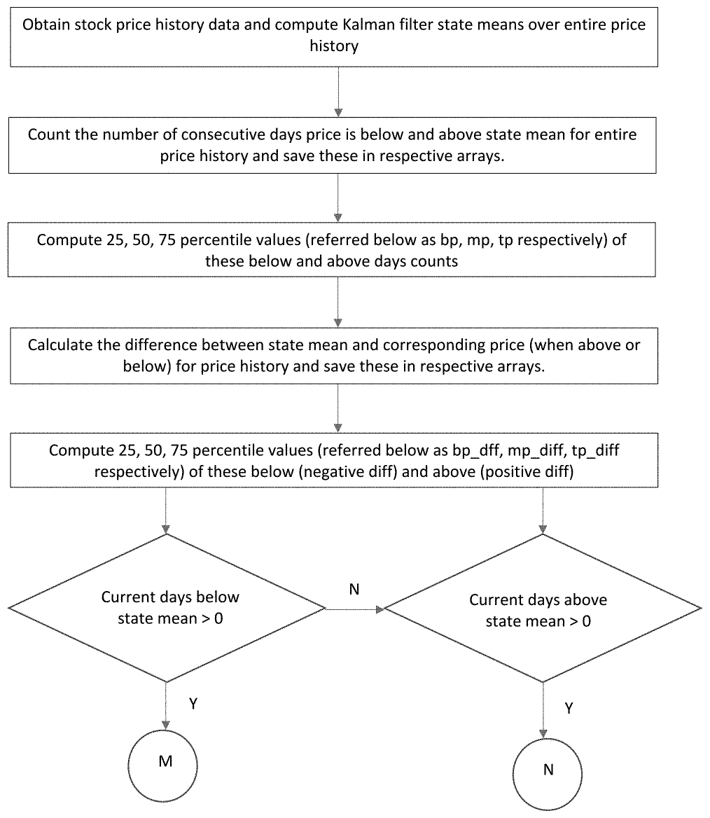

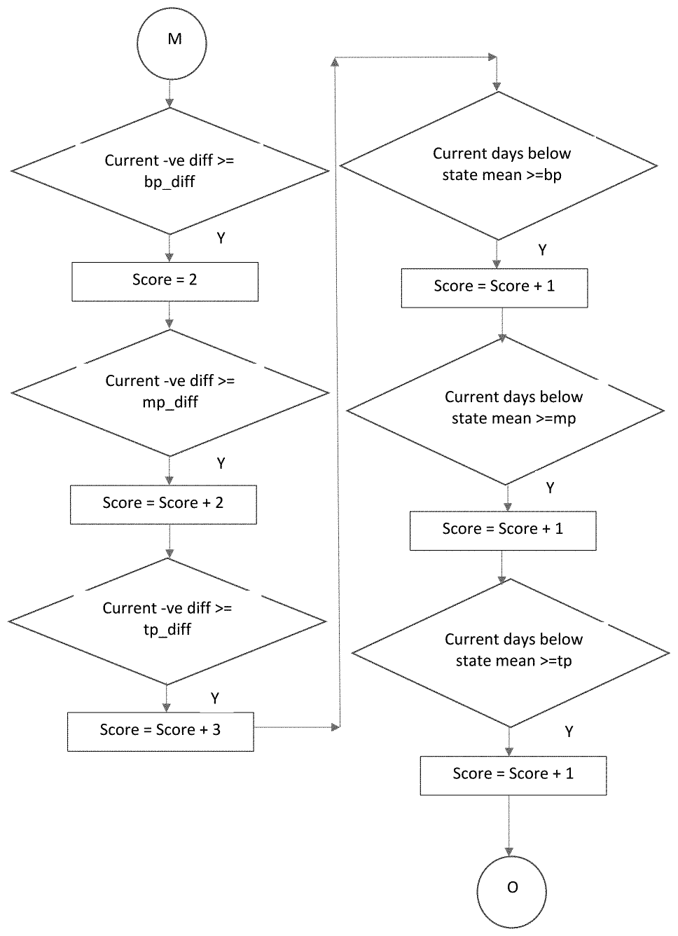

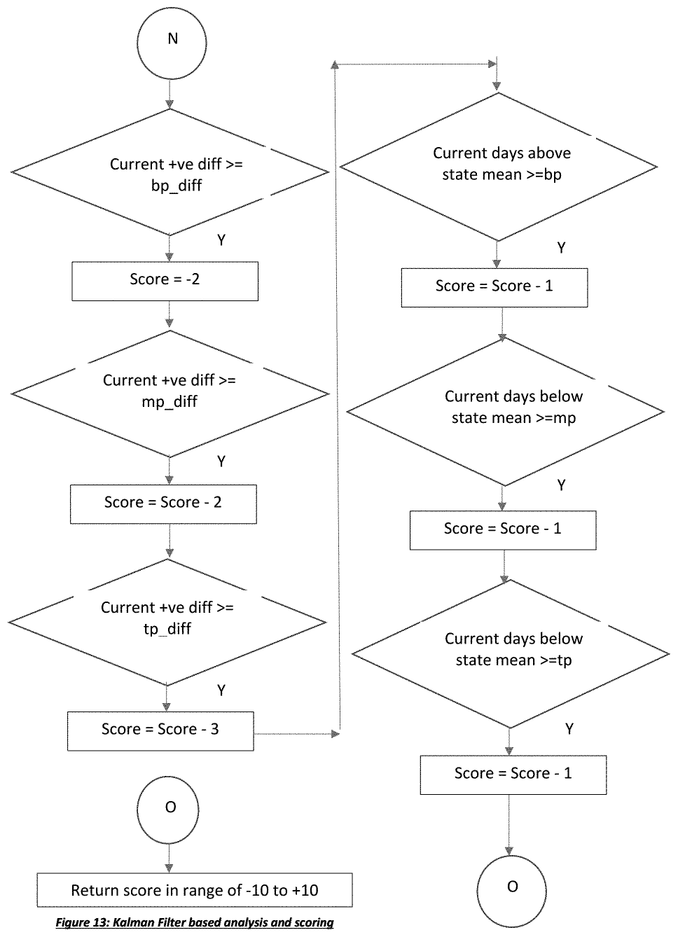

a) As shown in FIG. 12, this method uses price history data to compute MACD line and reference/signal line.

b) This method counts the historical number of days below/above signal line and computes 25, 50, 75 percentile values to compare with current number of days below/above signal line. For current below signal line count, this method assigns negative score if count is less than 25 percentile and proportionate positive score when count is in middle/top quantile. The intent is to interpret this as significant price drop might have already happened in bottom percentile and now it could start recovering so we want to buy before buy signal is seen. FIG. 12 shows this scoring in detail

c) This method computes the historical positive/negative differences between MACD and signal lines and computes 25, 50, 75 percentile values to compare with current positive/negative differences between MACD and signal lines. The score is computed proportionately depending on which quantile the current difference falls in. FIG. 12 shows this scoring in detail.

d) Score generated by this method from MACD analysis is in −10 to +10 range.

### 9) Details of Analysis and Scoring Based on Kalman Filter

In the context of stock analysis, Kalman filter is like a digital filter. It is used often in time series analysis for signal processing and econometrics to remove noisy measurements. More information on Kalman Filter can be found here:

https://en.wikipedia.org/wiki/Kalman filter

This method treats daily price fluctuations as noise and uses Kalman filter to filter out the fluctuations to produce an output that this method treats as an “estimated average line”. This line is then used to compare with the current price to determine if the price is below or above average and generates scores accordingly.

a) As shown in FIG. 13, this method uses Kalman Filter on price history data to compute state means line. This line is treated as “estimated average line”.

b) This method counts the historical number of days below/above “estimated average line” and computes 25, 50, 75 percentile values to compare with current number of days below/above “estimated average line”. Positive scoring when a greater number of current days below the “estimated average line” and negative scoring when more number of days above the “estimated average line”. The score is proportionate to where the current number of days fall in historical percentile values for number of above/below days. FIG. 13 shows this scoring in detail

c) This method computes the historical positive/negative differences between “estimated average line” and price at that instance and computes 25, 50, 75 percentile values to compare with current positive/negative differences between “estimated average line” and price. Positive scoring when a greater difference below the “estimated average line” and negative scoring when a greater difference above the “estimated average line”. The score is computed proportionately depending on which quantile the current difference falls in. FIG. 13 shows this scoring in detail.

d) Score generated by this method from Kalman Filter analysis is in −10 to +10 range.

### 10) Details of Analysis and Scoring Based on OLS Linear Regression

Predicting the mean is deemed as a regression problem. This method uses the Ordinary Least Squares line as the “estimated straight average line” (as opposed to Kalman filter state means line which is not a straight line). This method also uses the slope of this line to estimate if the stock price is in the uptrend or downtrend. More information on OLS can be found here: https://en.wikipedia.org/wiki/Ordinary least squares

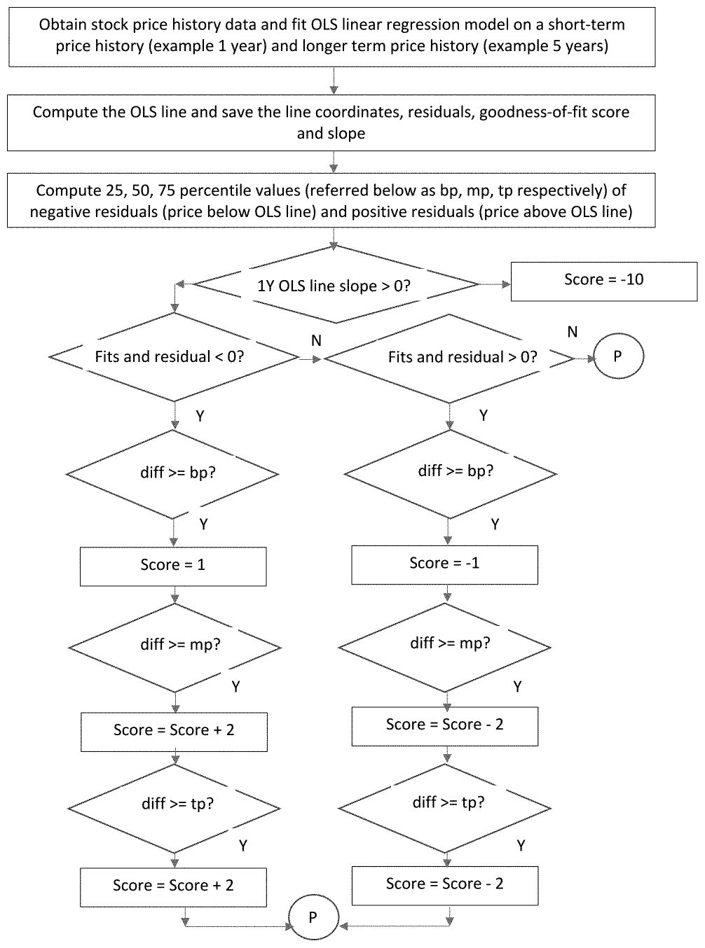

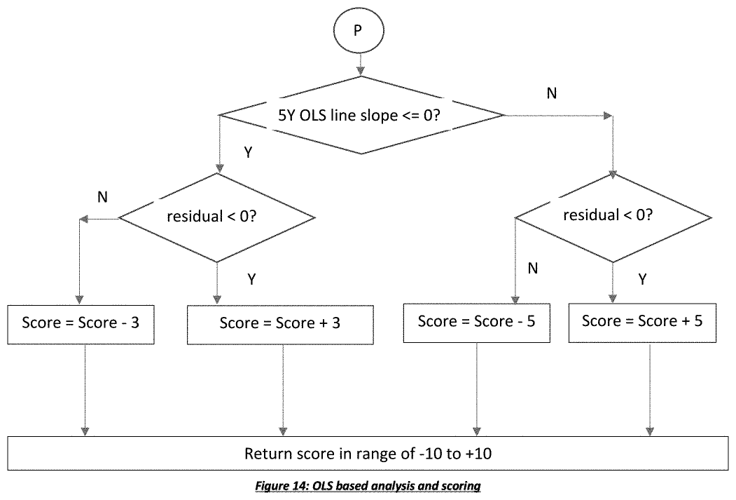

a) As shown in FIG. 14, this method uses OLS linear regression on price history data to compute OLS line that this method treats as the “estimated straight average line”.

b) This method computes slope of “estimated straight average line” to determine uptrend or downtrend. An uptrend results in positive scoring and downtrend results in negative scoring.

c) This method uses long term period and short-term period (example: 5 years and 1 year) to know both near term and longer-term trend

d) This method counts the historical number of days below/above “estimated straight average line” and computes 25, 50, 75 percentile values to compare with current number of days below/above “estimated straight average line”. Positive scoring when a greater number of current days below the “estimated straight average line” and negative scoring when a greater number of days above the “estimated straight average line”. The score is proportionate to where the current number of days fall in historical percentile values for number of above/below days. FIG. 14 shows this scoring in detail

e) This method computes the historical positive/negative differences between “estimated straight average line” and price at that instance and computes 25, 50, 75 percentile values to compare with current positive/negative differences between “estimated straight average line” and price. Positive scoring when a greater difference below the “estimated straight average line” and negative scoring when a greater difference above the “estimated straight average line”. The score is computed proportionately depending on which quantile the current difference falls in. FIG. 14 shows this scoring in detail.

f) The slope of “estimated straight average line” is also factored into scoring. FIG. 14. Show this scoring in detail

g) Score generated by this method from OLS analysis is in −10 to +10 range.

### 11) Details of Analysis and Scoring Based on Sentiment Scores from Social Media Websites

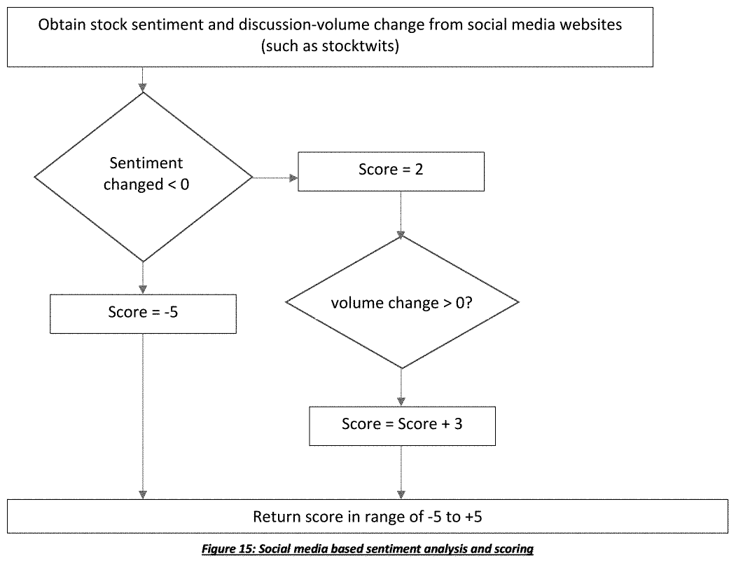

a) As shown in FIG. 15, this method obtains sentiment and discussion-volume change information of stocks from social media websites (such as stocktwits.com).

b) This method generates positive or negative score corresponding to positive or negative sentiment. Higher score is assigned based on the volume change. FIG. 15 shows the scoring detail

c) Score generated by this method from sentiment scores from social media websites is in −5 to +5 range.

### 12) Details of Final Overall Score

a) This method takes scores from steps 1-12 above and adds them all up then divides the result by 100 to produce a score that is in the range of −1 and +1.

### Source Code

If source code is required for further clarity, then this will help: Full source code of a fully working proof-of-concept of this method is here:

https://github.com/salylgw/gammath spot.git

The invention claimed is:

1. A method and tool to compute score of security to indicate the degree of perceived discount or perceived premium at its stock price. The method, comprised of analysis using technical indicators, linear regression, digital filtering, statistics, options data, industry analysts' recommendation data can be used efficiently in a software/tool that executes on computing system with processor, Random Access Memory, Storage and with or without Internet.

2. The method in claim 1 uses multiple technical indicators to suite different stock-conditions and establishes a historical average indicator point to compare with current indicator point to computes scores

3. The method in claim 1 uses multiple techniques to establish a historical average price to compare with current price to compute score

4. The method in claim 1 uses Ordinary Least Squares line slope to estimate up/down trend of the stock to factor into overall score

5. The method in claim 1 uses percentile system to determine values used to compute score

6. The method in claim 1 uses analysts' recommendations to factor into overall score

7. The method in claim 1 uses options data to estimate bullish/bearish trends to factor into overall score

8. The method in claim 1 uses social media sentiment score for stocks to factor into overall score

9. The method in claim 1 uses potential price reversal detection methods to factor into overall score

10. The method in claim 1 has 10% weightage for score from analysts' recommendation data analysis, 10% weightage for score from options data analysis, 10% weightage for score from historical price analysis, 10% weightage for RSI, 10% weightage for MFI, 10% weightage for Bollinger bands, 10% weightage for MACD, 5% weightage for Stochastic oscillator analysis, 5% weightage for stock sentiment analysis, 10% weightage for Digital filtering using Kalman Filter, 10% weightage for OLS analysis

11. Method in claim 1 returns final score (in the range −1 to +1) that is easy to understand for making buy/sell decision

12. Method in claim 1 can be run efficiently to compute score of single stock or multiple stocks quickly

13. Method in claim 1 can be used for long-term, short-term and day-trading

14. Method in claim 1 can be run on a variety of computing systems such as super computers, mainframes, cloud, personal computer, laptops, tablets, mobile phones etc.
